(19) United States
(12) Patent Application Publication
(10) Pub. No.: US 2002/0111415 A1
(43) Pub. Date: Aug. 15, 2002

(54) Thermoplastic materials with improved thermal conductivity and methods for making the same

(76) Inventors: Edward J. Mack SR., Bristol, RI (US); James P. Mack, Bristol, RI (US); Thomas P. Mack, Warren, RI (US)

Correspondence Address: EDWARDS & ANGELL, LPP, P.O. Box 9169, Boston, MA, 02209, US

(21) Appl. No.: 09/917,199

(22) Filed: Jul. 27, 2001

Related U.S. Application Data
(60) Provisional application No. 60/222,108, filed on Jul. 28, 2000.
(60) Provisional application No. 60/222,107, filed on Jul. 28, 2000.

(51) Int. Cl. C08K 3/04

(52) U.S. Cl. 524/496

(57) ABSTRACT

Thermally conductive polymeric materials, compositions and methods of making are provided. The materials include relatively high concentrations of thermally conductive filler materials, preferably fibrous filler materials. The compositions may be used is a variety of applications to form molded and extruded articles. sp

The present application claims the benefit of U.S. provisional application No. 60/222,108, filed on Jul. 28, 2000, incorporated herein by reference in its entirety.

### FIELD OF THE INVENTION

This invention relates to materials having improved thermal conductivity and methods of making the same. In particular, the invention relates to thermally conductive polymeric materials and methods of making thermally conductive polymeric materials comprising at least one polymeric material and at least one thermally conductive filler material, wherein the at least one thermally conductive filler material is present at relatively high concentrations.

### BACKGROUND OF THE INVENTION

Thermally conductive materials are used in a variety of applications where heat removal is required, including, for example, computers, electronic assemblies and components, battery cases, semiconductors, gas turbines and engines. Thermally conductive metals, such as aluminum and copper, have primarily been used as such thermally conductive materials. However, these materials are heavy, are prone to corrosion and difficult to form into various shapes.

Thermally conductive polymeric materials are relatively low weight and high strength materials that have recently replaced thermally conductive metals in many applications. These materials do not corrode and can be easily molded and formed into a desired shape.

Polymeric materials are generally made thermally conductive by incorporating thermally conductive filler materials into a base polymeric material. There are a wide variety of thermally conductive filler materials that may be incorporated onto a polymeric material. Such filler materials may include, for example, thermally conductive powders, flakes and fibers. The thermal conductivity of the polymeric material relates generally to the thermal conductivity of the filler material added to the base polymeric material. In the case of fibers, the length and orientation of the fibers impacts the thermal conductivity of the polymeric material. Generally higher concentrations of the filler material, greater lengths of the fibers and orientation of the fibers parallel to the heat flow will increase thermal conductivity of the base polymeric material to which the filler material is added.

However, with conventional methods, as higher concentrations of the filler material are added to the polymeric materials, the downstream processing of the materials, such as, for example, injection molding, is often adversely affected.

Further, as higher concentrations of the filler material are added to increase thermal conductivity of the base polymeric material, other important properties of the base polymeric material often deteriorate. For example, the addition of too much filler material can result in weakening of the polymeric material and, for example, can result in thermally conductive polymeric materials that are too brittle for their intended use. Thus, to date, the concentration of filler material that can be added to a base polymeric material has been limited.

Further, when thermally conductive fibers are incorporated into a base polymeric material, it is important to maintain the length of the fibers, as reducing the fiber length can reduce the thermal conductivity of the final polymeric material. Current methods do not adequately maintain the length of the fibers and, thus, provide polymeric materials having substantially limited thermal conductivities.

Thus, to date, the degree to which base polymeric materials may be made thermally conductive has been limited by a number of factors. The amount of thermally conductive filler that has been successfully added to polymeric materials has been limited. Further, the lengths of fibrous fillers are not adequately maintained using current methods. Still further, using current methods, thermal conductivity is often imparted on the base polymeric material only to compromise other important properties of the base polymeric material.

Accordingly, any improvements in thermally conductive polymeric materials and methods of making thermally conductive polymeric materials are desirable.

### SUMMARY OF THE INVENTION

The present invention relates to novel compositions and methods of making the same. More particularly, the present invention relates to improved thermally conductive polymeric materials, compositions for forming thermally conductive polymeric materials, and unique solvent-based methods of forming thermally conductive polymeric materials. The methods of the present invention produce thermally conductive polymeric materials having substantially improved thermal and mechanical properties, as compared with known thermally conductive polymers.

A preferred method for forming the thermally conductive polymeric materials in accordance with the present invention comprises: at least partially dissolving a polymeric material in a solvent, followed by adding a thermally conductive filler material to the solution. The conductive filler is dispersed in the polymer solution by gentle stirring or other low energy dispersion techniques, in order to improve the wettability, dispersability and shape retention of the filler, while providing good physical properties of the resulting composition. The solvent is then removed, for example, by allowing the solvent to evaporate through continued gentle stirring and/or application of heat. The resulting material can then be broken down for further downstream processing, such as injection molding, to form the end product.

Preferably the thermally conductive filler material has a thermal conductivity of at least about 300 W/M ° K, more preferably at least about 500 W/M ° K, more preferably, at least about 700 W/M ° K, more preferably, at least about 900 W/M ° K, and, more preferably, at least about 1100 W/M ° K.

Methods of the present invention achieve high loading levels of thermally conductive filler in the polymeric material. In preferred embodiments, the filler material is added in amounts of at least about 25 wt %, more preferably, at least about 30 wt %, more preferably, at least about 40 wt%, more preferably, at least about 50 wt %, more preferably, at least about 55 wt %, more preferably, at least about 60 wt %, more preferably, at least about 65 wt %, and still more preferably, at least about 70 wt %. The preferred ranges of conductive filler material in the thermally conductive polymeric material ranges from about 50% to about 75%, more preferably from about 55% to about 70%.

In accordance with preferred methods, the thermally conductive filler material is a fibrous filler, preferably carbon fiber, more preferably Thermalgraph DKD-A or Thermalgraph DKD-X. Methods of the present invention are particularly effective in minimizing fiber breakage, thereby further enhancing the thermal conductivity of the thermally conductive polymeric materials. Preferably, the length of the fibrous filler in the end product is substantially the same as the length of the fibrous filler before it is added to the solvent/polymeric material solution.

In some embodiments, the method further comprises adding a second thermally conductive filler material to the solvent/polymeric material solution. In preferred embodiments, the first filler material is a fibrous filler material, preferably carbon fibers, and the second filler material is a conductive particle having greater bulk or volume than the first filler. Preferred second fillers may be selected from boron nitride particles, aluminum flakes, Teflon® particles and Teflon® fibers, or other thermally conductive filler materials having greater particulate volume than the first thermally conductive filler.

Without wishing to be bound by theory, it is believed that the solvent-based method of producing the compositions of the present invention provides improved formation and orientation of a conductive matrix of thermally conductive particles, dispersed more uniformly throughout the material.

In an exemplary embodiment, the thermally conductive polymeric materials of the present invention comprise a polymeric material and a thermally conductive filler material. The thermally conductive filler material preferably has a thermal conductivity of at least about 300 W/M ° K, more preferably at least about 500 W/M ° K., more preferably, at least about 700 W/M ° K, more preferably, at least about 900 W/M ° K, and, more preferably, at least about 1100 W/M ° K.

In preferred embodiments, the thermally conductive filler material is a fibrous filler material, preferably carbon fibers, more preferably Thermalgraph DKD-A or Thermalgraph DKD-X carbon fibers. The fiber preferably has a length of at least about 200 μm. As used herein “fiber” and “fibrous material” means a fundamental form of solid (often crystalline) characterized by relatively high tenacity and an extremely high ratio of length to diameter.

Some suitable polymeric materials for use in forming the thermally conductive polymeric materials are well known in the art and include, by way of example, polyimides, polyethermides, polyetherketones, polyphenylene sulfides, liquid crystal polymers, and combinations thereof.

In preferred embodiments, the thermally conductive polymeric materials include at least about 25 wt % of the filler material, more preferably, at least about 30 wt %, more preferably, at least about 40 wt %, more preferably, at least about 50 wt %, more preferably, at least about 55 wt %, more preferably, at least about 60 wt %, more preferably, at least about 75 wt %, and, still more preferably, at least about 70 wt % of the filler material. The preferred ranges of conductive filler material in the thermally conductive polymeric material ranges from about 50% to about 75%, more preferably from about 55% to about 70%.

The thermally conductive polymeric materials may further include a second thermally conductive filler material. Suitable materials for use as the second thermally conductive filler material are well known in the art and include, by way of example, boron nitride, Teflon®, aluminum, copper, nickel, beryllium oxide, graphite, molybdenum disulfide, talc, tetrafluoroethylene. In one embodiment, the second filler is in particle form and has a mean particle size ranging from about 5 μm to about 10 μm. In preferred embodiments, the first filler material is a fiber, preferably carbon fiber, and the second filler material is a conductive particle having greater bulk or volume than the first filler. In a particularly preferred embodiment, the first filler comprises a carbon fiber, preferably Thermalgraph DKD-or Thermalgraph DKD-X, and the second filler comprises Teflon® particles, Teflon® fibers, aluminum flakes, or boron nitride particles.

Compositions for forming thermally conductive polymeric materials in accordance with the present invention comprise a polymeric material, a filler material and a solvent. The solvent is selected such that the polymeric material is at least partially soluble in the solvent. Methylene chloride and N-methyl pyrrolidone are two preferred solvents. Others suitable solvents are known in the art, especially in conjunction with particular polymer types.

In a preferred embodiment, the filler material comprise a fibrous filler material, preferably, carbon fiber, more preferably Thermalgraph DKD-A or Thermalgraph DKD-X.

The thermally conductive filler material preferably has a thermal conductivity of at least about 300 W/M ° K, more preferably at least about 500 W/M ° K, more preferably, at least about 700 W/M °K, more preferably, at least about 900 W/M ° K, and, more preferably, at least about 1100 W/M ° K.

Preferably, the composition includes at least about 25 wt % of the filler material, more preferably, at least about 30 wt %, more preferably, at least about 40 wt %, more preferably, at least about 50 wt %, more preferably, at least about 55 wt %, more preferably, at least about 60 wt %, more preferably, at least about 65 wt %, and still more preferably, at least about 70 wt % of the filler material. The preferred ranges of conductive filler material in the compositions ranges from about 50% to about 75%, more preferably from about 55% to about 70%.

In some embodiments, the compositions further include a second filler material, which is preferably also a heat conductive material. The second filler material is preferably selected from boron nitride particles, aluminum flakes, Teflon® particles and Teflon® fibers. In preferred embodiments, the first filler material is a fiber, preferably carbon fiber, and the second filler material is a conductive particle having greater bulk or volume than the first filler.

Other aspects and embodiments of the invention are discussed infra.

### DECRIPTION OF THE DRAWINGS

It should be understood that the drawings are provided for the purpose of illustration only and are not intended to define the limits of the invention. The foregoing and other objects and advantages of the embodiments described herein will become apparent with reference to the following detailed description when taken in conjunction with the accompanying drawings in which:

FIG. 1 is a table comparing the thermal conductivity of test specimens formed from the present materials and conventional materials.

### DETAILED DESCRIPTION OF THE INVENTION

The present invention provides thermally conductive polymeric materials having relatively high concentrations of thermally conductive filler. The present invention is also directed to compositions and methods for making the thermally conductive polymeric materials. Methods for making the thermally conductive polymeric materials in accordance with the present invention achieve high loading levels of thermally conductive filler in a polymeric material. Further, methods of the present invention minimize fiber breakage and maintain fiber orientation when the filler material is a fibrous filler material.

The thermally conductive polymeric materials comprise generally a base polymeric material and a thermally conductive filler material. In some embodiments, the thermally conductive polymeric materials may further include a second thermally conductive filler material.

There are no constraints on the type of polymeric material that may be used in the present structures and compositions, other than those related to practical considerations such as the processing methods used for the compositions and/or the application in which the plastic structure may be used. The polymeric matrix materials suitable for use in the present compositions may be in any form such as granules, pellets, and the like. Thus, any polymeric material may be used for the present compositions and structures, whether thermoplastic or thermosetting. In preferred embodiments, the polymeric material is a thermoplastic. The polymeric materials may be amorphous, crystalline, semi-crystalline, and any combination thereof. Some examples of suitable polymeric materials include, by way of example, acetals, acrylics, flouropolymers, ketone-based polymers, liquid crystal polymers (LCP), phenolics, polyamides (nylons) (PA), polyamideimide (PAI), polyarylate, polybutylene terephthalate (PBT), polycarbonate (PC), polyetherimide (PEI), polyethylene (PE), polyethylene naphthalate (PEN), polyethylene terephthalate (PET), thermoplastic polyimide (TPI), polyphenylene sulfide (PPS), polypropylene (PP), silicones, sulfone-based polymers, and combinations thereof. As stated previously, the polymeric matrix material may be a blend of at least two polymeric matrix materials.

Some commercially available polymeric materials that have been found suitable for use in the present invention include Aurem 6200 (a moldable virgin PI manufactured by Mitsui Toatsu in Japan); Cycloy Grade C 1110-100 (a blend of PC and ABS resins, available from General Electric Corporation); Nylon 6-12 (available from DuPont Corporation); PPS (polyphenylene sulfide, e.g. product number 020584, natural fine grade powder manufactured by the Ticona Corp); Ultem 1010 (PEI manufactured by General Electric Corp); Vectra C 950 (a virgin LCP manufactured by the Ticona Corp); and Victrex PEEK Grade 150 (manufactured by the Victrex Corporation).

“Filler material” as used herein, means any material that may be incorporated into a polymeric material. Filler materials that have been found suitable for use as the first and second thermally conductive filler materials generally have relatively high thermal conductivity and relatively high lubricity in comparison to other filler materials. Thermally conductive filler materials suitable for use in the present invention are well known in the art and include, by way of example, carbon, Teflon®, aluminum, copper, nickel, boron nitride, beryllium oxide, graphite, molybdenum disulfide, talc, tetrafluoroethylene and combinations thereof.

Some commercially available filler materials that have been found suitable for the present compositions include Carbotherm CTFS (Boron Nitride powder available from the Carborundum Corporation; mean particle size is 5-10 microns); Solvent 110-20-E (Aluminum Pigment concentrate available from Silberline Manufacturing Corporation Incorporated, including about 20% resin and about 80% aluminum pigments having a particle size of about 23 microns); Teflon® fibers (polytetrafluoroethylene fibers available from DuPont Corporation); Thermalgraph DKD-A (a carbon fiber available from Amoco); Thermalgraph DKD-X (a carbon fiber available from Amoco); and Transmit K102 (aluminum flakes available from the Transmit Corporation having dimensions of 1 mm×1.3 mm×30 microns and a bulk density of 0.32 grams/cc).

The first filler material may be selected from any thermally conductive filler material known in the art and, preferably, has a thermal conductivity of at least about 300 W/M ° K. More preferably, first filler material has a thermal conductivity of at least about 500 W/M ° K, more preferably, at least about 700 W/M ° K, more preferably, at least about 900 W/M ° K, and, more preferably, at least about 1100 W/M °°K.

The first filler material is preferably a fibrous filler material, preferably carbon fiber. The fibers are preferably long and continuous, but the present method can also provide improvements with discontinuous, milled, or chopped particles, and combinations thereof. In preferred embodiments, the fibers have a length of at least about 200 μm and a diameter of about 10 μm.

One particularly preferred material for use as the first thermally conductive filler is a graphitized pitch-based carbon fiber. Generally, as the degree of graphitization of a carbon fiber increases, so does the density and the thermal conductivity of the carbon fiber. Pitch-based carbon fibers generally have a relatively higher graphite content than polyacrylonitrile (PAN) carbon fibers and are consequently more highly lubricious than PAN carbon fibers. Pitch-based carbon fibers and methods of production are disclosed, inter alia, in U.S. Pat. Nos. 5,552,098; 5,601,794; 5,612,015; 5,620,674; 5,631,086; 5,643,546; 5,654,059; 5,705,008; 5,721,308; and 5,750,058. Examples of graphitized pitch-based carbon fibers that have been found suitable for use in the present invention include Dialead K 223HG and Dialead K 223HG LG (hereinafter “HG” and “LG,” respectively, both available from Mitsubishi Chemical America) and Thermalgraph® DKD and DKA (hereinafter “DKD” and “DKA,” respectively, both available from BPAmoco). These fibers are generally characterized by a relatively high concentration of graphite crystals which are oriented axially in the fibers.

The HG and LG fibers have a tensile strength of greater than about 450 KSI, a tensile modulus of greater than about 130 MSI, a density of about 2.2 gm/cm³, a T_{c} , of about 540 W/M ° K, and an average diameter of about 7 microns. In addition to the foregoing, the HG fibers have an average length of about 300 μm; the LG fibers have an average length of about 6000 μm.

The DKD fibers have a tensile strength of greater than about 200 KSI, a tensile modulus ranging from about 100 to about 135 MSI, a density ranging from about 2.15 to about 2.25 gm/cm³, a carbon assay of 99+ percent, and a CET of about −1.445 ppm/° C. The DKD fibers also have a diameter of about 10 microns and a length distribution in which less than 20 percent of the fibers are less than 100 μm and less than 20 percent of the fibers are greater than 300 μm.

The DKA fibers have a tensile strength of greater than about 350 KSI, a tensile modulus ranging from about 130 to about 145 MSI, a density ranging from about 2.15 to about 2.25 gm/cm³, a carbon assay of 99+ percent, and a CET of about −1.45 ppm/° C. The DKA fibers also have a an average diameter of about 10 μm and an average length of about 200 μm.

The Thermalgraph DKD-A and DKD-X carbon fibers are particularly preferred as filler materials due to their relatively high thermal conductivity and because they are fibrous. ThermalGraph DKD-A has a thermal conductivity in the fiber direction of about 300 to about 1,100 W/M ° K. ThermalGraph DKD-X has a thermal conductivity in the fiber direction of about 800 to about 1,100 W/M ° K. Thermalgraph DKD-A and DKD-X fibers are unusually sensitive to fiber break-down during blending and molding and, thus, require careful handling and processing methods that minimize fiber break-down.

The thermally conductive polymeric materials of the present invention contain relatively large amounts of thermally conductive filler material and possess substantially improved thermal and mechanical properties. In preferred embodiments, the thermally conductive polymeric material contains at least about 25 wt % of the first thermally conductive filler, more preferably, at least about 30 wt %, more preferably, at least about 40 wt %, more preferably, at least 50 wt %, more preferably, at least about 55 wt %, more preferably, at least 60 wt %, more preferably, at least about 65 wt %, and more preferably, at least 70 wt % of the first thermally conductive filler. The preferred ranges of conductive filler material in the thermally conductive polymeric material ranges from about 50% to about 75%, more preferably from about 55% to about 70%.

The thermally conductive polymeric materials can further include, in addition to the thermally conductive filler material set out above, a second thermally conductive filler material. The second filler material can include any thermally conductive filler material known in the art, including, but not limited to, carbon, Teflon®, aluminum, copper, nickel, boron nitride, beryllium oxide, graphite, molybdenum disulfide, talc, tetrafluoroethylene and combinations thereof. The thermal conductivity of the second filler material is not particularly limited. However, the second filler material preferably has a relatively high thermal conductivity in comparison to other filler materials.

Preferably, when both a first and second thermally conductive filler material are included, combinations of at least two types of filler materials are preferred. Without being bound by theory, it is believed that when the compositions of the present invention include at least two types of filler materials, the filler materials act synergistically to provide fmal polymeric materials having unexpectedly high thermal conductivity values.

In preferred embodiments, the first filler material is a fiber, preferably carbon fiber, and the second filler material is a conductive particle having greater bulk or volume than the first filler. Preferred second fillers are selected from boron nitride particles, aluminum flakes, Teflon® particles and Teflon® fibers, or other thermally conductive filler materials having greater particulate volume than the first thermally conductive filler. In a particularly preferred embodiment, the first filler material is a carbon filler, preferably Thermalgraph DKD-A or DKD-X, and the second filler material is selected from Teflon® fibers, Teflon® powder, aluminum flakes, boron nitride powder and combinations thereof.

If desired, additional filler materials may be added to provide whatever additional properties such filler materials normally would be expected to impart to the final polymeric materials. Examples of some suitable additional filler materials include, by way of example, graphite, glass fibers, metallic oxides, mica, talc, bronze, copper, aluminum, silver, molybdenum, Fiberfrax, and the like. The amount of additional filler material that may be added to the composition may be limited due to the exceptionally high loading of thermally conductive filler already achieved.

The thermally conductive polymers of the present invention attain thermal conductivity values of at least 1 W/M ° K. Preferred ranges of thermal conductivity values for the thermally conductive polymers of the present invention range from about 1 W/M ° K to about 3.6 W/M ° K and, more preferably, from about 1.1W/M ° K to about 3.5 W/M ° K.

Compositions for forming the thermally conductive polymer materials comprise, in general, at least one polymeric base material, at least one thermally conductive filler material and a solvent. In some embodiments, the compositions for forming the thermally conductive thermoplastic polymer further include a second thermally conductive filler material.

Suitable materials for use as the polymeric material, the first filler material and the second filler material are set out above. As further set out above, additional filler materials in addition to the first and second thermally conductive filler materials can be added to provide whatever tadditional properties such filler materials normally would be expected to impart to the final polymeric materials.

Suitable solvents for use in the present compositions are those in which the polymeric base material is at least partially soluble. Thus, the solvents will depend on the base polymeric material that is used. These solvents may be readily determined by one of skill in the art and include, by way of example, methylene chloride (available from Dow Chemical Corporation) and N-methyl pyrrolidone (available from by BASF Corp). Methylene chloride and N-methyl pyrrolidone have excellent wetting characteristics and, thus, polymeric solutions of methylene chloride and N-methylene pyrrolidone will effectively disperse, encapsulate, and separate individual particles of filler. Moreover, N-methyl pyrrolidone is water soluble. Thus, in fabricating the thermally conductive thermoplastic polymer materials, the N-methyl pyrrolidone can be removed from the composition by simply adding water. In this manner, the solvent may be easily and fully removed, resulting in thermally conductive thermoplastic polymer materials with unexpectedly high filler concentrations.

The compositions for forming the thermally conductive thermoplastic polymer preferably comprise at least about 25 wt % of the first thermally conductive filler, more preferably at least about 30 wt %, more preferably at least about 40 wt %, more preferably at least about 50 wt %, more preferably, at least about 55 wt %, more preferably at least about 60 wt %, more preferably, at least about 65 wt %, and more preferably at least about 70 wt % of the first thermally conductive filler material. The polymeric base material is preferably added in amounts no greater than 75 wt %, more preferably, no greater than 70 wt %, more preferably, no greater than 60 wt %, more preferably, no greater than 50 wt %, more preferably, no greater than 40 wt %, and more preferably, no greater than 30 wt %. The preferred ranges of conductive filler material in the thermally conductive polymeric material ranges from about 50% to about 75%, more preferably from about 55% to about 70%.

The solvent is added in amounts sufficient to dissolve the polymeric base material and may be readily determined by one of skill in the art. For example, the solvent can be slowly added to the polymeric material until the polymeric material is at least partially dissolved. For example, in one embodiment, as shown in the Examples below, approximately 100 grams of polymeric base material (Ultem 1010) is added to and dissolved in approximately 900 grams of solvent (methylene chloride or N-methylene pyrrolidone).

In another embodiment, compositions for forming the thermally conductive thermoplastic polymer comprise, in general, at least one polymeric material, a first thermally conductive filler material and a second thermally conductive filler material. Suitable materials for use as the polymeric material, the first filler and the second filler are set out above. In a preferred embodiment, the first filler material is a fiber, preferably a carbon fiber, more preferably Thermalgraph DKD-A or DKD. The fibers preferably have a length of at least about 200 μm and a diameter of about 10 μm. The second material is preferably selected from Teflon® fibers, Teflon® powder, aluminum flakes or boron nitride powder.

Methods for forming thermally conductive polymeric materials in accordance with the present invention provide thermally conductive polymeric materials having exceptionally high thermal conductivity. The present invention utilizes methods that achieve high loading levels of thermally conductive filler in a base polymeric material without substantial adverse affects on the properties of the base polymeric material or the filler particles. Further, methods of the present invention that utilize thermally conductive fibrous filler materials effectively minimize fiber break-down. For example, DKA and DKD fibers have very high thermal conductivities and, thus, would be desirable to use in thermally conductive polymeric materials. However, DKA and DKD fibers are unusually sensitive to fiber break-down, which can reduce their ability to impart thermal conductivity, and, thus, present special problems in blending and molding. The methods of the present invention effectively minimize fiber breakage and effectively maintain the length, shape and orientation of thermally conductive fibers in the composition, while ensuring homogeneity of the composition.

It has been found that the wettability and dispersability of a filler material in the melt stage of a polymeric material is less than the wettability and dispersability of a filler material when the polymeric material is dissolved in a solvent. The wettability and dispersability of the filler material depends on the ability of the polymeric material to encapsulate and separate individual particles/flakes/fibers of filler material. The methods of the present invention increase the wettability and dispersability of the filler material(s), thereby increasing the effectiveness of the filler material(s) to impart thermal conductivity on the polymeric material.

There are several methods that may be used to form thermally conductive polymeric materials in accordance with the present invention, including dry blending techniques, extrusion blending techniques, solvent blending techniques, and modified solvent blending techniques using concentrates of one or more thermally conductive filler materials.

In one embodiment, thermally conductive polymeric materials of the present invention are made using a dry blending technique. In this embodiment, the polymeric base material and the one or more filler materials are mixed in dry form, preferably at room temperature, and are tumbled to obtain a fairly uniform mixture. Thereafter, it is generally desirable to add the mixture to a pulverizing machine, such as a hammer mill, to grind and further mix the resinous components to ensure homogeneity. In practice, it has been found particularly desirable to pass the mixture at least four times through a hammer mill pulverizer having a ⅛-inch screen (with holes preferably about one inch in diameter). The resulting polymeric material may be processed further, for example, using an injection molding process, to form the desired end product.

In another embodiment, thermally conductive polymeric materials of the present invention are made using an extrusion blending technique. The extrusion blending technique involves blending the polymeric base material with the one or more filler materials, preferably using a twin screw extruder or similar blending device, which is well known to those of skill in the art. After extrusion, the thermally conductive solid polymeric material may be broken and granulated by, for example, adding the material to a pulverizing machine, such as a hammer mill, to grind and further mix the resinous components to ensure homogeneity. The resulting polymeric material may be processed further, for example, using an injection molding process, to form the desired end product. However, high sheer stresses in the twin screw extruder, while advantageous for obtaining good mixing of the components, can break down the length of the fibers.

A preferred method of the present invention is a solvent blending method. In accordance with this method, at least one base polymeric material is dissolved in a suitable solvent. A thermally conductive filler material is then added to the solution. The conductive filler is then dispersed in the polymer solution by gentle stirring or other low energy dispersion techniques, in order to improve the wettability, dispersability and shape retention of the filler, while providing good physical properties of the resulting composition. Stirring can be continued until the filler material is completely wetted out and until the solvent substantially evaporates. Evaporation of the solvent produces a relatively thick suspension of filler material in the dissolved polymeric material. Thereafter, the residual solvent is removed, for example, by drying in a heated oven, or, in the case of a water soluble solvent such as N-methyl pyrrolidone, this can be accomplished by simply adding water. The resulting material may then be broken-down and granulated by, for example, adding the material to a pulverizing machine, such as a hammer mill, followed by further downstream processing, such as an injection molding processes, to form the desired end product.

In accordance with the above method, solvent blending of the thermally conductive filler material(s) in the polymeric material achieves high loading of the filler material(s) in the polymeric material, maintains the length of fibrous fillers and achieves complete dispersion and distribution of the filler material(s) in the polymeric material. Injection molding of the resulting material maintains the orientation of the filler material(s). Combination of these two processes provides thermally conductive polymeric materials having exceptionally high thermal conductivity without substantial adverse affects on the properties of the base polymeric material or the filler particles.

In some embodiments, the method further includes, after dissolving at least one base polymeric material in a suitable solvent, adding a second thermally conductive filler material to the solution.

Further, if desired or necessary, the method may further include adding other filler materials to the solution to provide whatever additional properties such filler materials normally would be expected to impart to the final polymeric materials.

Suitable polymeric materials, thermally conductive filler materials, solvents and additional fillers for use in the solvent blending methods are set out above.

In a particularly preferred solvent blending method of the present invention, at least one base polymeric material selected from acrylonitrile butadiene styrene (ABS), liquid crystal polymer (LCP), Nylon, polycarbonate (PC), polyetherimide (PEI), polyetheretherketone (PEEK), polyimide (PI), polyphenylene sulfide (PPS), and combinations thereof, is dissolved in a solvent selected from methylene chloride and N-methyl pyrrolidone. A first thermally conductive filler material is then added to the solution. The first filler material is preferably a fibrous filler, preferably carbon fiber, more preferably Thermalgraph DKD-A or DKD-X. A second thermally conductive filler material, preferably different than the first filler material, preferably selected from Teflon® fibers, Teflon® powder, aluminum flakes and boron nitride powder, is also added to the solution. The conductive filler is then dispersed in the polymer solution by gentle stirring or other low energy dispersion techniques to wet out the filler material. The gentle stirring or other low energy dispersion technique is continued until the solvent substantially evaporates. This produces a relatively thick suspension of filler material in the dissolved polymeric material, with residual solvent. Thereafter, the residual solvent is removed by transferring the mixture into a container and drying in a heated oven at about 300° F. for a period of time to remove remaining solvent. The resulting material may then be broken-down and granulated for further downstream processing, such as an injection molding processes, to form the desired end product.

Another method in accordance with the present invention is a variation of the afore-mentioned solvent method, and is useful for polymeric matrix materials that are not soluble in ordinary solvents or may not be available in, for example, fine grinds. Generally, it has been difficult or impossible to blend large amounts of additive(s), especially fibrous material, with dry blended granules. Therefore, the present method solves the problem by forming a first solvent blend having a high concentration of additive(s) (typically about 60 wt % to about 90 wt %) from a polymeric matrix material that is compatible with the desired polymeric matrix material and adding the desired polymeric matrix material to the first solvent blend. For example, PEI is soluble in methylene chloride and is compatible with PI, LCP, PEEK, and PPS. Therefore, PEI may be selected as the polymeric matrix material to make the concentrated solvent blend. As described above, high concentrations of filler material(s) may be dispersed in the solution of the polymeric matrix and solvent. The mixture then may be dried out and granulated. The granules can then be blended with, for example, PI, PEEK, LCP, and/or PPS, or any other desired polymeric matrix material. These blends of granules can be easily fed into, for example, an injection molding machine, to form the desired end product.

Preferably, the concentration of filler material(s) in the concentrates is at least about 80 wt %, more preferably at least about 85 wt %, and more preferably still at least about 90 wt %. Preferred embodiments of the method provide concentrates having about 90 wt % of the foregoing preferred filler material(s).

The methods of the present invention achieve high loading of thermally conductive filler material(s) in a base polymeric material without substantial adverse affects on the properties of the base polymeric material. In preferred embodiments, at least about 25 wt % of the thermally conductive filler is added to the base polymeric material, more preferably, at least about 30 wt %, more preferably, at least about 40 wt %, more preferably, at least 50 wt %, more preferably, at least about 55 wt %, more preferably, at least 60 wt %, more preferably, at least about 65 wt %, and more preferably, at least 70 wt %. The preferred ranges of conductive filler material in the thermally conductive polymeric material ranges from about 50% to about 75%, more preferably from about 55% to about 70%.

The methods of the present invention produce thermally conductive polymers having a thermal conductivity of at least 1 W/M ° K, preferably ranging from about 1 W/M ° K to about 3.6 W/M ° K and, more preferably, ranging from about 1.1 W/M ° K to about 3.5 W/M ° K.

The compositions, however obtained, are very useful and articles formed from the composition have exceptionally high thermal conductivity. The final thermally conductive polymeric materials may be used, for example, in computers, electronic assemblies and components, battery cases, semiconductors, gas turbines, engines, and similar articles subjected to high temperature. Further, the compositions may be used to form articles that may be subjected to high temperature, high friction, high loads, and high wear. One example of such an article is a high performance bearing, in particular, as described in commonly-owned and co-pending U.S. patent application filed on Apr. 11, 2001. Such bearings may be formed by, for example, injection molding. Molding of the present polymeric materials is carried out with great care in order to maintain the integrity of the filler material. When molding with a screw injection molding machine, care is exercised to reduce shear as much as possible by use of a large nozzle, a zero compression screw, large runners, and large gates. Suitable results have been obtained by using, for example, an old-fashioned ram injection molding machine, which generally provides a minimum amount of shear. It is critical in a production run to check the density of the molded parts, as they may appear satisfactory while having a low density, resulting in as much as fifty-percent reduction in the thermal conductivity.

All documents mentioned herein are incorporated by reference herein in their entirety.

The present invention will be further illustrated by the following examples, which are intended to be illustrative in nature and are not to be considered as limiting the scope of the invention.

### EXAMPLE 1

The effectiveness of the foregoing solvent blending method was demonstrated by preparing six compositions shown below in Table 1. In each instance, a mixture was prepared by dissolving about 100 grams of Ultem 1010 in about 900 grams of a solvent, followed by the addition of about 400 grams of total filler material. In samples 1-3, the solvent used was methylene chloride. In samples 4-6, the solvent used was N-methyl pyrrolidone. The filler material used in samples 1-6 was Thermalgraph DKD-A, boron nitride, or a combination thereof. The resulting mixture was stirred slowly until the filler material was completely “wetted out.” Stirring of the resulting mixture was continued until a thick suspension was formed. The suspension was then transferred into a container and placed in an oven at 300° F. to remove any residual solvent.

TABLE

| | | | Filler |
|---|---|---|---|
| Sample | Polymer Material | Solvent | Material(s) |
| 1 | Ultem 1010 | Methylene | carbon fiber |
| | (100 g) | chloride | (400 g) |
| | | (900 g) | |
| 2 | Ultem 1010 | Methylene | boron nitride |
| | (100 g) | chloride | (400 g) |
| | | (900 g) | |
| 3 | Ultem 1010 | Methylene | carbon fiber & |
| | (100 g) | chloride | boron nitride |
| | | (900 g) | (400 g) |
| 4 | Ultem 1010 | N-methyl | carbon fiber |
| | (100 g) | pyrrolidone | (400 g) |
| | | (900 g) | |
| 5 | Ultem 1010 | N-methyl | boron nitride |
| | (100 g) | pyrrolidone | (400 g) |
| | | (900 g) | |
| 6 | Ultem 1010 | N-methyl | carbon fiber & |
| | (100 g) | pyrrolidone | boron nitride |
| | | (900 g) | (400 g) |

The resulting solid polymeric material was granulated for use in a process. About 500 grams of granulated material was formed in each instance.

### EXAMPLE 2

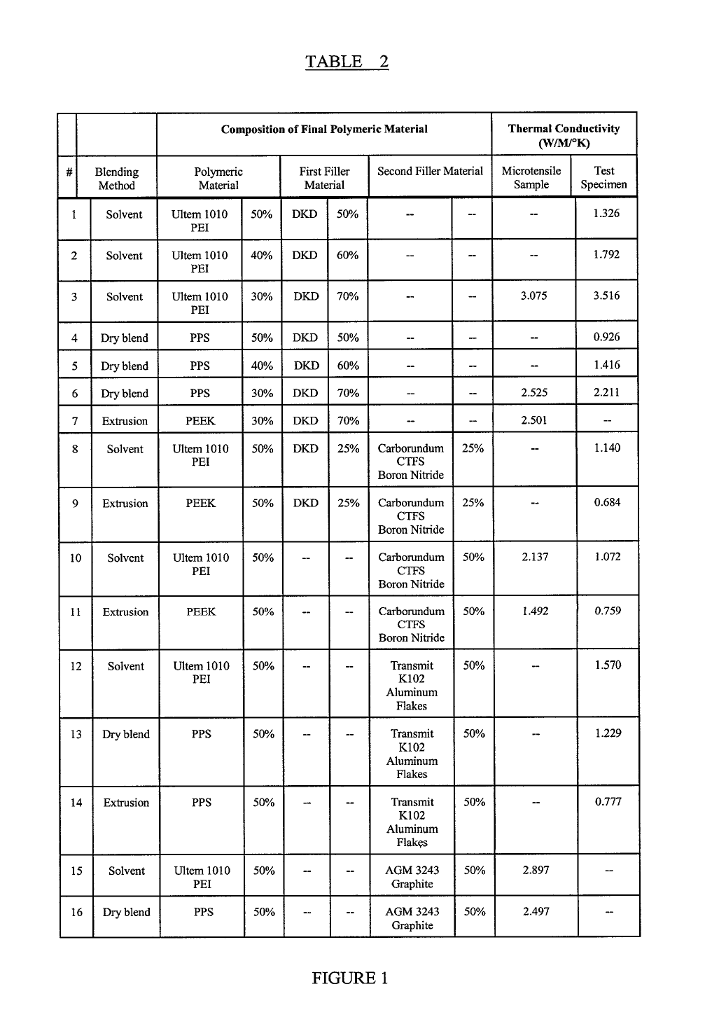

A variety of compositions and blending techniques were used to form polymeric materials having the compositions shown in FIG. 1 (Table 2). The polymeric materials were used to form test specimens measuring 2½″×½×¼″, and ground flat on both sides. Each specimen was tested using test equipment, which includes a Digis Block heat sink (manufactured by Laboratory Devises Inc.), a temperature controller with a “T” type probe (Modbus controlled temperature controller manufactured by the Presys. Corporation), a lap top computer with Excel, and a software program in Excel called “the Wedge.”

The heat sink was set with a ΔT of 40° C. above room temperature. The bottom of the test specimen was covered with a conductive paste to improve thermal contact (paste contained boron nitride and white oil) to the heat sink. A file was prepared on Excel, conditions were set on “the wedge” program, the wedge was turned on, and the specimen and the thermocouple were placed on the heat sinks.

The temperature measurements were placed into column one of the spreadsheet at the rate of two reading per second. The thermocouple and the sample were withdrawn after approximately 30 seconds and the Wedge program was halted.

The sample data was graphed. The first 10 to 15 readings formed a constant slope. A linear equation was automatically plotted and the slope was recorded. This yielded a rate of increase °/sec, calculated at 2×the reading (two reading were taken per second.) The rate of temperature increase, ° C./sec correlated with thermal conductivity, and was is a much faster way of rating the thermal conductivity of plastics up to approximately 7W/M ° K. Beyond 7 W/M ° K, the test was not accurate.

### CONCLUSIONS

The results of tests 1-3, and 4-6, demonstrate that the solvent blending method may be used to increase the concentration of the filler material and, therefore, the thermal conductivity of the polymeric material. The results of tests 1-3, and 4-6, also demonstrate the effectiveness of the solvent blending method for achieving compositions containing up to about 70 percent, by weight, of a fiber, while maintaining substantially high thermal conductivity values.

The results of tests 12-14 demonstrate the superiority of the solvent blending method in comparison to the extrusion and dry blending methods.

The results of tests 1, 10, and 12 shows that aluminum flake provides superior thermal conductivity results in comparison to both boron nitride powder and DKD in compositions formed using the solvent blending method.

Taken as a whole, the test results demonstrate the effectiveness of the solvent blending method for achieving compositions containing up to about 70 percent, by weight, of a fibrous filler material and up to about 50 percent of a flake or powder filler material, while maintaining substantially high thermal conductivity values. The test results also demonstrate the superiority of the solvent blending method in comparison to the extrusion and dry blending methods with respect to achieving and maintaining substantially high thermal conductivity values. In addition, the test results show that a variety of polymeric materials and filler materials may be used to achieve thermal conductivity values that are substantially higher than conventional materials.

Although particular embodiments of the invention have been described in detail for purposes of illustration, various changes and modifications may be made without departing from the scope and spirit of the invention. All combinations and permutations of the compositions and methods of forming the compositions are available for practice in various applications as the need arises.

What is claimed:

1. A composition for forming a thermally conductive polymeric material, comprising:
a least one thermoplastic polymeric material;
a thermally conductive filler material; and
at least one solvent in which the at least one thermoplastic polymeric material is at least partially soluble.

2. The composition of claim 1, wherein the filler material is a fiber.

3. The composition of claim 2, wherein the fiber is a carbon fiber.

4. The composition of claim 1, wherein the composition includes at least 55 wt % of the filler material.

5. The composition of claim 1, wherein the composition includes at least 60 wt % of the filler material.

6. The composition of claim 1, wherein the composition includes at least 70 wt % of the filler material.

7. The composition of claim 1, wherein the composition further comprises a second thermally conductive filler material.

8. The composition of claim 7, wherein the second filler material is selected from boron nitride particles, Teflon fibers, Teflon particles and aluminum flakes.

9. A thermally conductive polymeric material, comprising:
at least one polymeric material; and
at least 55 wt % of a thermally conductive filler material; and

10. The thermally conductive polymeric material of claim 9, wherein the thermally conductive filler material is a fiber.

11. The thermally conductive polymeric material of claim 10, wherein the fiber is a carbon fiber.

12. The thermally conductive polymeric material of claim 11, wherein the fiber length is at least about 200 μm.

13. The thermally conductive polymeric material of claim 9, further comprising a second filler material.

14. The thermally conductive polymeric material of claim 13, wherein the second filler material is selected from boron nitride particles, Teflon fibers, Teflon particles and aluminum flakes.

15. The thermally conductive polymeric material of claim 9, comprising at least 60 wt % of the filler material.

16. The thermally conductive polymeric material of claim 10, comprising at least 70 wt % of the filler material.

17. A method for forming a thermally conductive polymeric material, the method comprising the steps of:
forming a solution by at least partially dissolving a thermoplastic polymeric material in a solvent;
adding a thermally conductive filler material to the solution; and
removing the solvent from the solution.

18. The method of claim 17, wherein the filler material is a fiber.

19. The method of claim 18, wherein the fiber is a carbon fiber.

20. The method of claim 18, wherein the length of the fiber before forming the solution is substantially the same as after removing the solvent from the solution.

21. The method of claim 17, wherein the filler material is added in an amount of at least about 55 wt %.

22. The method of claim 17, wherein the filler material is added in an amount of at least about 60 wt %.

23. The method of claim 17, wherein the filler material is added in an amount of at least about 70 wt %.

24. The method of claim 17, further comprising the step of adding a second thermally conductive filler material to the solution.

25. A solvent blending method for forming a thermally conductive polymeric material by blending a thermally conductive fibrous filler with a polymeric material, wherein the length of the thermally conductive fibrous filler after blending is substantially the same as the length of the thermally conductive fibrous filler after forming the thermally conductive polymeric material.

26. A method for minimizing fiber breakage when forming a thermally conductive polymeric material comprising:
forming a solution by at least partially dissolving a polymeric material in a solvent;
adding a thermally conductive filler material to the solution, the thermally conductive filler material comprising fibers; and
removing the solvent from the solution.
